(19) United States
(12) Patent Application Publication
(10) Pub. No.: US 2025/0225944 A1
(43) Pub. Date: Jul. 10, 2025

(54) DISPLAY DEVICE AND METHOD OF OPERATING A DISPLAY DEVICE

(71) Applicant: Samsung Display Co., LTD., Yongin-si (KR)

(72) Inventors: SEUNG-WOON SHIN, Yongin-si (KR); WOON-ROK JANG, Yongin-si (KR); TAE-SEOK HA, Yongin-si (KR)

(21) Appl. No.: 18/970,322

(22) Filed: Dec. 5, 2024

(30) Foreign Application Priority Data
Jan. 10, 2024 (KR) 10-2024-0004124

(51) Int. Cl. G09G 3/3291; G09G 3/3266

(52) U.S. Cl. CPC G09G 3/3291; G09G 3/3266; G09G 2300/0426; G09G 2310/061; G09G 2310/08; G09G 2320/0233; G09G 2320/043; G09G 2330/021

(57) ABSTRACT

A display device includes a display panel including pixels, and a panel driver configured to drive the display panel at a variable frame frequency, to sequentially apply data voltages to the pixels on a row basis in an active period of a frame period, and to perform a sensing operation on at least one pixel among the pixels in a blank period of the frame period, wherein, within the blank period, the panel driver is configured to change an initialization voltage applied to the at least one pixel according to the variable frame frequency and according to a position of the at least one pixel.

### CROSS-REFERENCE TO RELATED APPLICATION(S)

The present application claims priority to, and the benefit of, Korean Patent Application No. 10-2024-0004124, filed on Jan. 10, 2024, in the Korean Intellectual Property Office, the entire disclosure of which is incorporated herein by reference

### BACKGROUND

### 1. Field

Embodiments of the present disclosure relate to a display device that performs a sensing operation, and a method of operating the display device.

### 2. Description of the Related Art

Even when pixels included in a display device, such as an organic light-emitting diode (OLED) display device, are manufactured by a common process, driving transistors of the plurality of pixels may have different driving characteristics (e.g., different mobility and/or different threshold voltages) from each other due to a process variation, or the like. Thus, the plurality of pixels may emit light with different luminance. Further, as the display device operates over time, the plurality of pixels may be degraded, and the driving characteristics of the driving transistors may be degraded.

To compensate for non-uniformity of luminance and for the degradation, the display device may perform a sensing operation that senses the driving characteristics of the driving transistors of the plurality of pixels. For example, to sense the driving characteristics of the driving transistors while the display device operates, a real-time sensing operation that senses the driving characteristic of at least one pixel in a blank period of each frame period may be performed.

### SUMMARY

Some embodiments provide a display device capable of reducing or preventing luminance of a pixel on which a sensing operation is performed in a blank period from being changed.

Some embodiments provide a method of operating a display device capable of reducing or preventing change of luminance of a pixel on which a sensing operation is performed in a blank period.

According to embodiments, there is provided a display device including a display panel including pixels, and a panel driver configured to drive the display panel at a variable frame frequency, to sequentially apply data voltages to the pixels on a row basis in an active period of a frame period, and to perform a sensing operation on at least one pixel among the pixels in a blank period of the frame period, wherein, within the blank period, the panel driver is configured to change an initialization voltage applied to the at least one pixel according to the variable frame frequency and according to a position of the at least one pixel.

The panel driver may be configured to increase the initialization voltage within the blank period as the variable frame frequency decreases.

The panel driver may be configured to increase the initialization voltage within the blank period as a distance of the at least one pixel from an edge of the display panel increases.

The at least one pixel may include a driving transistor including a gate connected to a gate node, a first terminal connected to a first power supply voltage line, and a second terminal connected to a source node, a scan transistor including a gate that receives a scan signal, a first terminal connected to a data line, and a second terminal connected to the gate node, a sensing transistor including a gate that receives a sensing signal, a first terminal connected to a sensing line, and a second terminal connected to the source node, a storage capacitor including a first electrode connected to the gate node, and a second electrode connected to the source node, and a light-emitting element including an anode connected to the source node, and a cathode connected to a second power supply voltage line.

The blank period may include an initialization period in which a sensing data voltage is to be applied to the gate node and the initialization voltage is to be applied to the source node, a sensing period in which the sensing operation is to be performed, and a rewrite period in which a previous data voltage is to be applied to the gate node and the initialization voltage is to be applied to the source node.

The initialization voltage may be changed after the initialization period and before the rewrite period.

The initialization voltage may be changed within the sensing period.

The previous data voltage may include a data voltage applied to the at least one pixel in the active period.

The panel driver may include a sensing channel configured to perform the sensing operation, an initialization switch configured to apply the initialization voltage to the sensing line in response to an initialization switching signal, and a sampling switch configured to connect the sensing line to the sensing channel in response to a sampling switching signal.

In the initialization period, the initialization switching signal, the scan signal, and the sensing signal have an on-level, and the sampling switching signal has an off-level, the initialization switch is configured to apply the initialization voltage to the sensing line in response to the initialization switching signal having the on-level, the scan transistor is configured to turned on in response to the scan signal having the on-level, and to transfer the sensing data voltage of the data line to the gate node, the sensing transistor is configured to be turned on in response to the sensing signal having the on-level, and to transfer the initialization voltage of the sensing line to the source node, and the storage capacitor is configured to store a voltage difference between the sensing data voltage and the initialization voltage.

The initialization switching signal may be configured to be changed from an on-level to an off-level between the initialization period and the sensing period, wherein the initialization voltage begins to be increased when the initialization switching signal is changed from the on-level to the off-level.

In the sensing period, the sensing signal and the sampling switching signal have an on-level, and the initialization switching signal and the scan signal have an off-level, the sensing transistor is configured to be turned on in response to the sensing signal having the on-level, and to connect the source node to the sensing line, the driving transistor is configured to generate a sensing current based on a voltage difference between the sensing data voltage and the initialization voltage, the sampling switch is configured to connect the sensing line to the sensing channel in response to the sampling switching signal having the on-level, and the sensing channel is configured to sense the sensing current through the sensing line.

In the rewrite period, the scan signal, the sensing signal, and the initialization switching signal have an on-level, and the sampling switching signal has an off-level, the initialization switch is configured to apply the initialization voltage to the sensing line in response to the initialization switching signal having the on-level, the scan transistor is configured to be turned on in response to the scan signal having the on-level, and to transfer the previous data voltage of the data line to the gate node, the sensing transistor is configured to be turned on in response to the sensing signal having the on-level, and to transfer the initialization voltage of the sensing line to the source node, and the storage capacitor is configured to store a voltage difference between the previous data voltage and the initialization voltage.

The panel driver may include a data driver connected to the pixels through data lines, a power management circuit configured to provide a first power supply voltage, a second power supply voltage, and the initialization voltage to the display panel, a sensing circuit connected to the pixels through sensing lines, and a controller connected to control the data driver, the sensing circuit, and the power management circuit.

In the frame period, the controller may be configured to select one pixel row on which the sensing operation is performed within the blank period among pixel rows of the display panel.

The controller may include an initialization voltage lookup table configured to store the initialization voltage in a rewrite period according to the variable frame frequency with respect to panel regions into which the display panel is divided along a vertical direction, wherein the controller is configured to control the power management circuit to change the initialization voltage within the blank period.

The initialization voltage lookup table may be configured to store a first initialization voltage at a maximum frame frequency and a second initialization voltage at a minimum frame frequency with respect to the panel regions, wherein the controller is configured to read, from the initialization voltage lookup table, the first initialization voltage and the second initialization voltage for one of the panel regions to which the at least one pixel belongs, and to determine the initialization voltage corresponding to the variable frame frequency in the rewrite period by interpolating the first initialization voltage and the second initialization voltage.

According to embodiments, there is provided a display device including a display panel including pixels, and a panel driver configured to drive the display panel at a fixed frame frequency in a normal mode, to drive the display panel at a variable frame frequency in a variable frame mode, to sequentially apply data voltages to the pixels on a row basis in an active period of a frame period, and to perform a sensing operation on at least one pixel among the pixels in a blank period of the frame period, wherein, in the normal mode, the panel driver is configured to apply an initialization voltage that is constant to the display panel, and wherein, in the variable frame mode, the panel driver is configured to change the initialization voltage applied to the at least one pixel within the blank period.

According to embodiments, there is provided a method of operating a display device configured to drive a display panel at a variable frame frequency, the method including sequentially applying data voltages on a row basis to pixels in an active period of a frame period, performing a sensing operation on at least one pixel among the pixels within a blank period of the frame period, changing an initialization voltage applied to the at least one pixel according to the variable frame frequency and according to a position of the at least one pixel, and applying a previous data voltage and the changed initialization voltage to the at least one pixel within the blank period.

The initialization voltage within the blank period may be configured to increase as the variable frame frequency decreases, and to increase as a distance of the at least one pixel from an edge of the display panel increases.

As described above, in a display device and a method of operating the display device according to embodiments, within a blank period of a frame period, a sensing operation for a pixel may be performed, and an initialization voltage applied to the pixel may be changed according to a variable frame frequency and a position of the pixel. Accordingly, change of luminance of the pixel on which the sensing operation is performed in the blank period may be reduced or prevented, and a horizontal bright line may not be perceived in a display panel.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a circuit diagram illustrating an example of a pixel included in a display device according to embodiments.

FIG. 3 is a timing diagram illustrating an example of scan and sensing signals applied to a display panel that is driven at a variable frame frequency.

FIG. 4 is a diagram illustrating an example of an initialization voltage in an active period and a blank period in a case where the initialization voltage is not changed.

FIG. 5 is a diagram illustrating examples of luminance of pixels on which a sensing operation is performed according to variable frame frequencies and positions of the pixels in a case where the initialization voltage is not changed.

FIG. 6A is a diagram illustrating an example of a display panel that is divided into a plurality of panel regions.

FIG. 6B is a diagram illustrating an example of an initialization voltage lookup table according to embodiments.

FIG. 7 is a diagram illustrating examples of luminance of pixels on which a sensing operation is performed in a display device according to embodiments.

FIG. 8 is a flowchart illustrating a method of operating a display device according to embodiments.

FIG. 9 is a timing diagram for describing an operation of a pixel in which a sensing operation is performed in a blank period and an operation of a sensing circuit in a display device according to embodiments.

FIG. 10 is a circuit diagram for describing an example of operations of a pixel and a sensing circuit in an initialization period within a blank period.

FIG. 11 is a circuit diagram for describing an example of operations of a pixel and a sensing circuit in a sensing period within a blank period.

FIG. 12 is a circuit diagram for describing an example of operations of a pixel and a sensing circuit in a rewrite period within a blank period.

FIG. 13 is a flowchart illustrating a method of operating a display device according to embodiments.

FIG. 14 is a block diagram illustrating an example of an electronic device according to embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that the present disclosure covers all modifications, equivalents, and replacements within the idea and technical scope of the present disclosure, that each of the features of embodiments of the present disclosure may be combined with each other, in part or in whole, and technically various interlocking and operating are possible, and that each embodiment may be implemented independently of each other, or may be implemented together in an association, unless otherwise stated or implied.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first- category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

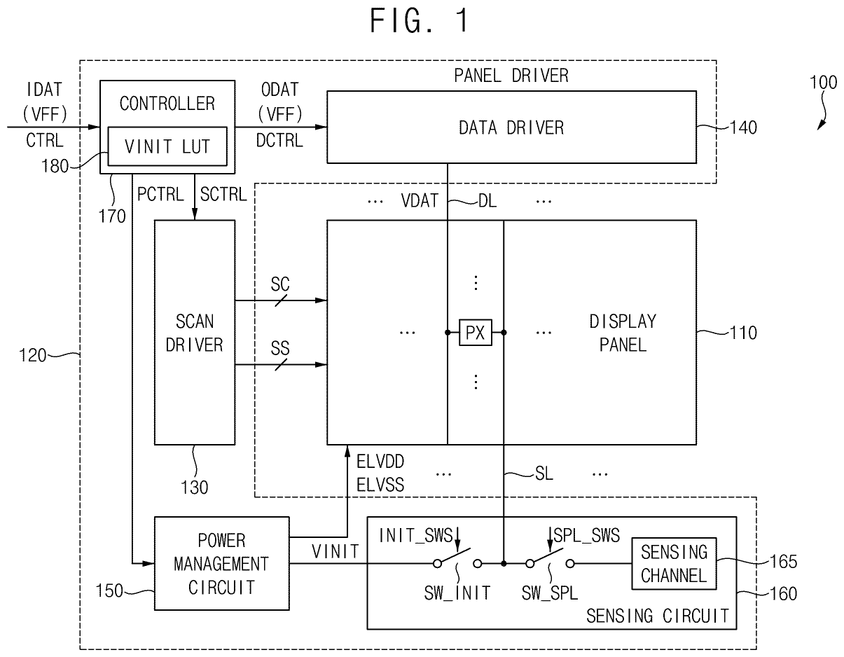

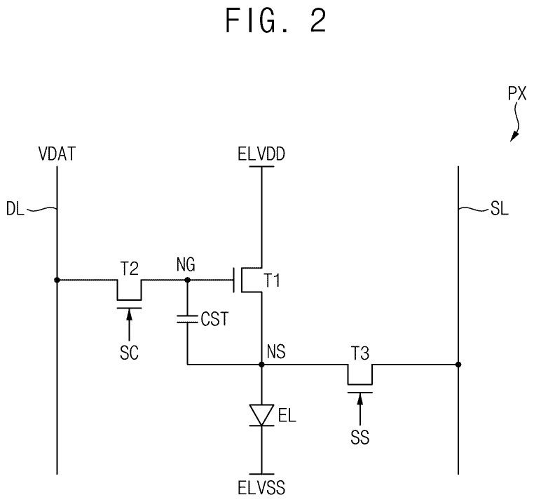

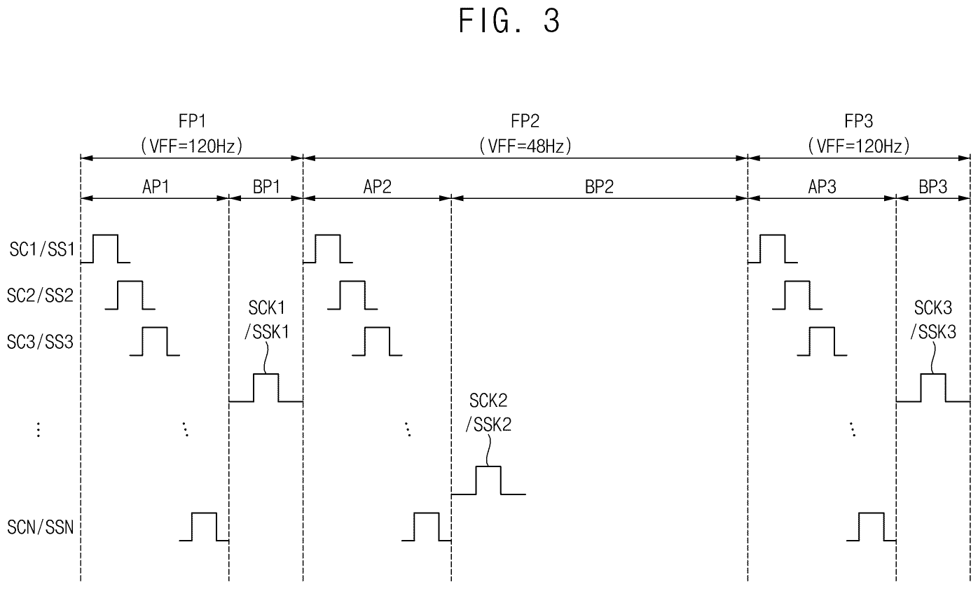

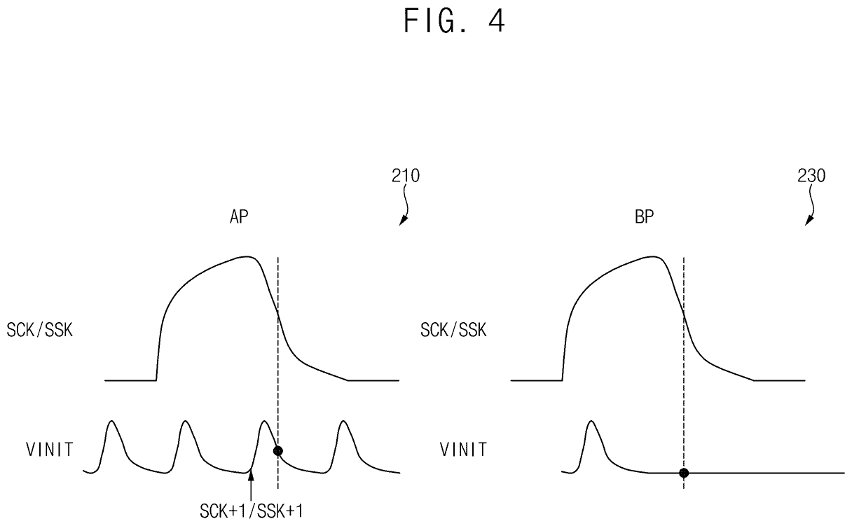

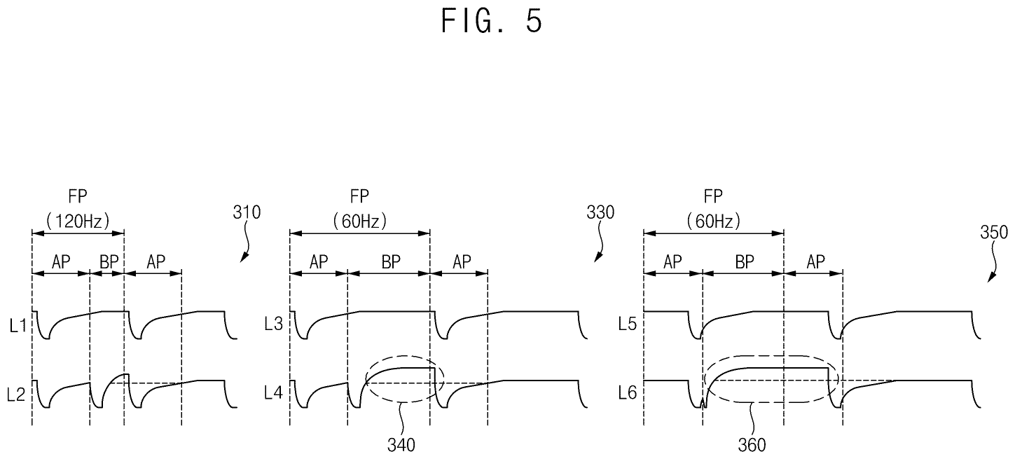

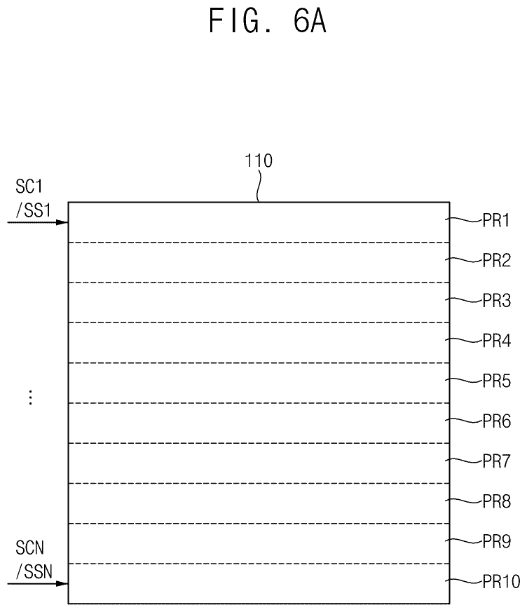

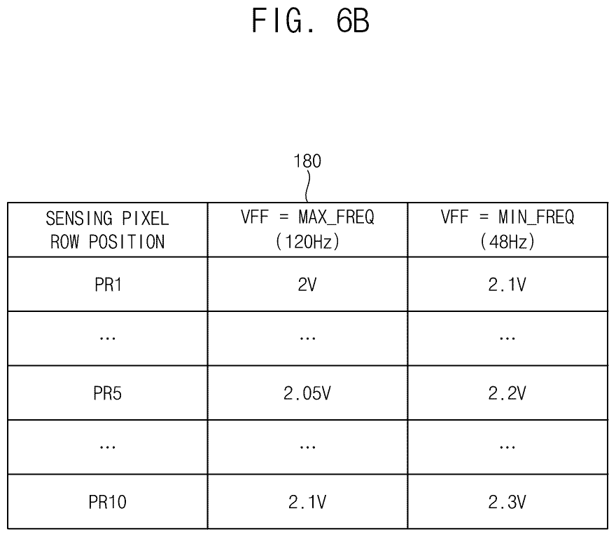

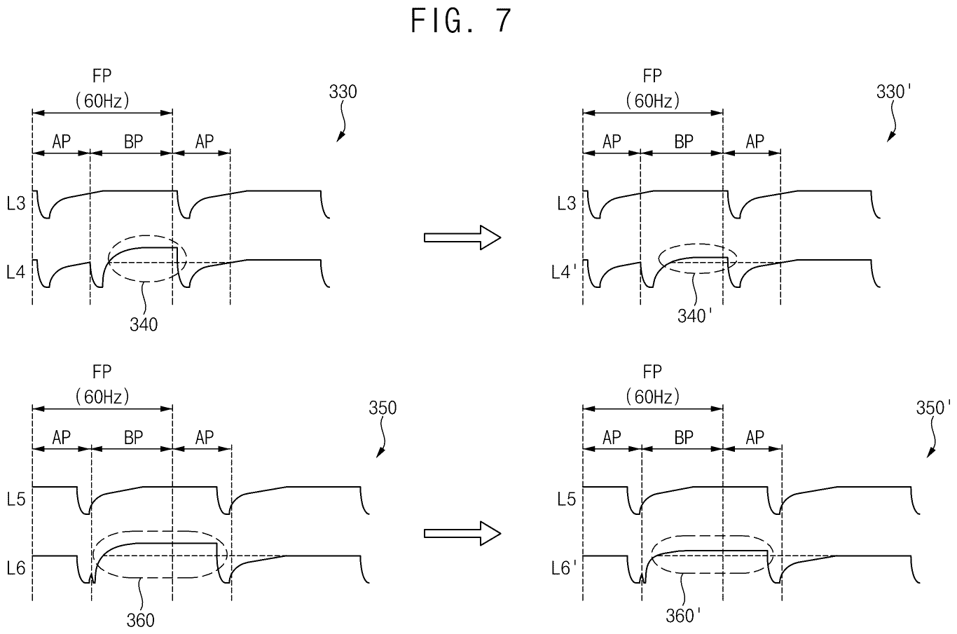

FIG. 1 is a block diagram illustrating a display device according to embodiments, FIG. 2 is a circuit diagram illustrating an example of a pixel included in a display device according to embodiments, FIG. 3 is a timing diagram illustrating an example of scan and sensing signals applied to a display panel that is driven at a variable frame frequency, FIG. 4 is a diagram illustrating an example of an initialization voltage in an active period and a blank period in a case where the initialization voltage is not changed, FIG. 5 is a diagram illustrating examples of luminance of pixels on which a sensing operation is performed according to variable frame frequencies and positions of the pixels in a case where the initialization voltage is not changed, FIG. 6A is a diagram illustrating an example of a display panel that is divided into a plurality of panel regions, FIG. 6B is a diagram illustrating an example of an initialization voltage lookup table according to embodiments, and FIG. 7 is a diagram illustrating examples of luminance of pixels on which a sensing operation is performed in a display device according to embodiments.

Referring to FIG. 1, a display device 100 according to embodiments may include a display panel 110 that includes a plurality of pixels PX, and a panel driver 120 that drives the display panel 110. In some embodiments, the panel driver 120 may include a scan driver 130 that provides scan signals SC and sensing signals SS to the plurality of pixels PX, a data driver 140 connected to the plurality of pixels PX through data lines DL, a power management circuit 150 that provides a first power supply voltage ELVDD, a second power supply voltage ELVSS, and an initialization voltage VINIT to the display panel 110, a sensing circuit 160 connected to the plurality of pixels PX through sensing lines SL, and a controller 170 that controls the scan driver 130, the data driver 140, the power management circuit 150, and the sensing circuit 160.

The display panel 110 may include the data lines DL, the sensing lines SL, and the plurality of pixels PX connected to the data lines DL and the sensing lines SL. The display panel 110 may further include scan signal lines for providing the scan signals SC to the plurality of pixels PX, and sensing signal lines for providing the sensing signals SS to the plurality of pixels PX. In some embodiments, each pixel PX may include a light-emitting element, and the display panel 110 may be a light-emitting display panel.

For example, as illustrated in FIG. 2, each pixel PX may include a driving transistor T1, a scan transistor T2, a sensing transistor T3, a storage capacitor CST, and a light-emitting element EL.

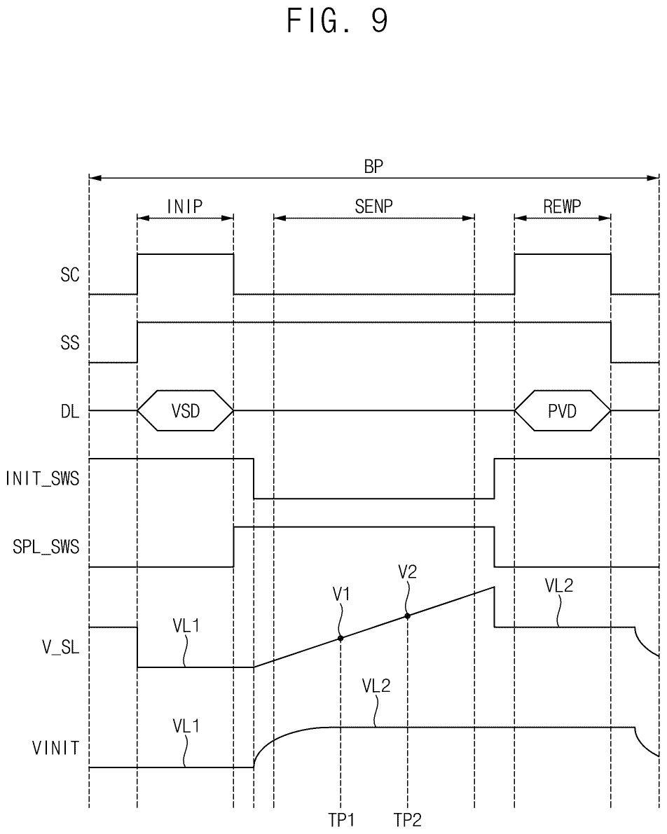

The storage capacitor CST may store a voltage difference between a data voltage VDAT (alternatively, a sensing data voltage VSD or a previous data voltage PVD illustrated in FIG. 9) transferred through the data line DL and the initialization voltage VINIT transferred through the sensing line SL. In some embodiments, the storage capacitor CST may include a first electrode connected to a gate node NG, and a second electrode connected to a source node NS.

The scan transistor T2 may connect the data line DL to the gate node NG in response to the scan signal SC. Thus, the scan transistor T2 may transfer the data voltage VDAT of the data line DL to the gate node NG in response to the scan signal SC. In some embodiments, the scan transistor T2 may include a gate that receives the scan signal SC, a first terminal connected to the data line DL, and a second terminal connected to the gate node NG.

The sensing transistor T3 may connect the sensing line SL to the source node NS in response to the sensing signal SS. In some embodiments, the sensing transistor T3 may include a gate that receives the sensing signal SS, a first terminal connected to the sensing line SL, and a source connected to the source node NS.

The driving transistor T1 may generate a driving current based on the voltage difference stored in the storage capacitor CST. In some embodiments, the driving transistor T1 may include a gate connected to the gate node NG, a first terminal (e.g., a drain) connected to a first power supply voltage line that transfers the first power supply voltage ELVDD (e.g., a high power supply voltage), and a second terminal (e.g., a source) connected to the source node NS.

The light-emitting element EL may emit light based on the driving current generated by the driving transistor T1. For example, the light-emitting element EL may be, but is not limited to, an organic light-emitting diode (OLED), a nano light-emitting diode (NED), a quantum dot (QD) light-emitting diode, a micro light-emitting diode, an inorganic light-emitting diode, or any other suitable light-emitting element. In some embodiments, the light-emitting element EL may include an anode connected to the source node NS, and a cathode connected to a second power supply voltage line that transfers the second power supply voltage ELVSS (e.g., a low power supply voltage).

Although FIG. 2 illustrates an example of the pixel PX, the pixel PX of the display device 100 according to embodiments is not limited to the example of FIG. 2.

The scan driver 130 may generate the scan signals SC and the sensing signals SS based on a scan control signal SCTRL received from the controller 170, and may sequentially provide the scan signals SC and the sensing signals SS to the pixels PX on a row basis in an active period of a frame period. For example, as illustrated in FIG. 3, in the active period AP1, AP2, and AP3 of each frame period FP1, FP2, and FP3, the scan driver 130 may sequentially output the scan signals SC1, SC2, SC3, . . . , SCN and the sensing signals SS1, SS2, SS3, . . . , SSN (e.g., from a first scan signal SC1 and a first sensing signal SS1 for a first pixel row, to an N-th scan signal SCN and an N-th sensing signal SSN for an N-th pixel row) on a row basis (or a row-by-row basis), where N is an integer greater than 1. Within a blank period BP1, BP2, and BP3 of each frame period FP1, FP2, and FP3, to perform a sensing operation on at least one pixel PX, the scan driver 130 may provide the scan signal SCK1, SCK2, and SCK3 and the sensing signal SSK1, SSK2, and SSK3 to the at least one pixel PX. In some embodiments, in each blank period BP1, BP2, and BP3, one pixel row may be randomly selected from among a plurality of pixel rows of the display panel 110, and the scan driver 130 may provide the scan signal SCK1, SCK2, and SCK3 and the sensing signal SSK1, SSK2, and SSK3 to the randomly selected pixel row. In some embodiments, the scan control signal SCTRL may include, but is not limited to, a start signal and a clock signal. Further, in some embodiments, the scan driver 130 may be integrated or formed in the display panel 110. In other embodiments, the scan driver 130 may be implemented as one or more integrated circuits.

The data driver 140 may generate the data voltages VDAT based on output image data ODAT and a data control signal DCTRL received from the controller 170, and may provide the data voltages VDAT to the plurality of pixels PX in the active period. Further, in the active period, the scan driver 130 may sequentially provide the scan signals SC and the sensing signals SS on a row basis, and thus the data driver 140 may sequentially provide the data voltages VDAT to the plurality of pixels PX on the row basis. In some embodiments, the data control signal DCTRL may include, but is not limited to, a data enable signal, a horizontal start signal, and a load signal.

Further, in the blank period, as illustrated in FIG. 9, the data driver 140 may apply the sensing data voltage VSD to at least one pixel PX on which a sensing operation is performed. Further, within the blank period, after the sensing operation is performed, the data driver 140 may apply the previous data voltage PVD to the at least one pixel PX. Here, the previous data voltage PVD may be the data voltage VDAT applied to the at least one pixel PX in the active period immediately before the sensing operation is performed. For example, in a case where a data voltage VDAT corresponding to a 48-gray level is applied to the at least one pixel PX in the active period, within the blank period, after the sensing operation is performed on the at least one pixel PX, the data voltage VDAT corresponding to the 48-gray level may be again applied as the previous data voltage PVD to the at least one pixel PX.

In some embodiments, the data driver 140 may be implemented as one or more integrated circuits. In other embodiments, the data driver 140 and the controller 170 may be implemented as a single integrated circuit, and the single integrated circuit may be referred to as a timing controller embedded data driver (TED) integrated circuit.

The power management circuit 150 may generate voltages ELVDD, ELVSS, and VINIT for an operation of the display device 100. In some embodiments, the power management circuit 150 may generate the first power supply voltage ELVDD, the second power supply voltage ELVSS, and the initialization voltage VINIT provided to the display panel 110. Further, in some embodiments, the initialization voltage VINIT generated by the power management circuit 150 may be selectively applied to the sensing line SL of the display panel 110 through an initialization switch SW_INIT of the sensing circuit 160. In some embodiments, the power management circuit 150 may be implemented as an integrated circuit, which may be referred to as a power management integrated circuit (PMIC). In other embodiments, the power management circuit 150 may be included in the controller 170 or the data driver 140.

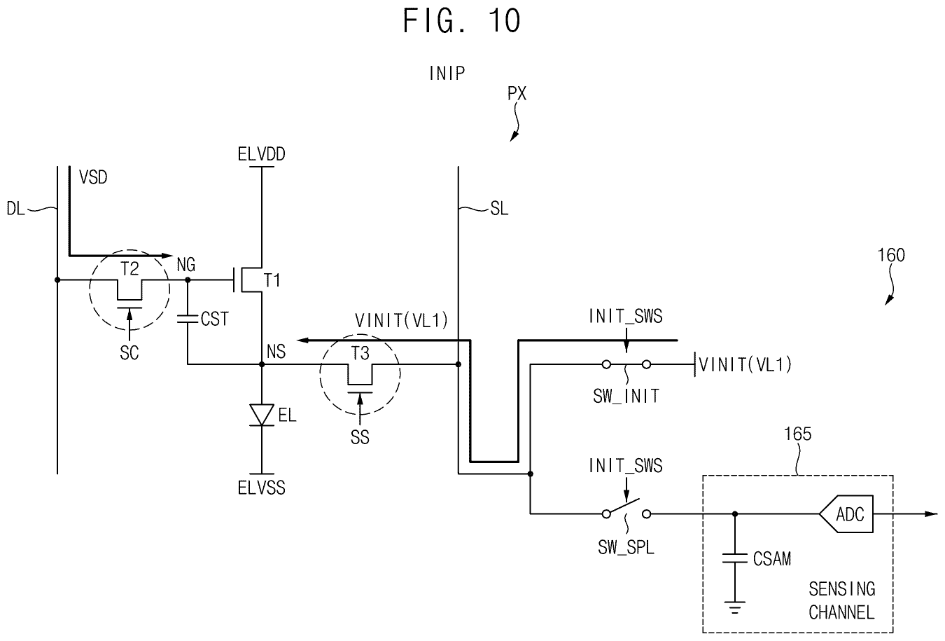

The sensing circuit 160 may sense a driving characteristic of at least one pixel PX through the sensing line SL. For example, the sensing circuit 160 may sense the driving characteristic (e.g., a mobility and/or a threshold voltage) of the driving transistor T1 by measuring a sensing current (or a sensing voltage) of the driving transistor T1 of the at least one pixel PX through the sensing line SL. In some embodiments, the sensing circuit 160 may include, but is not limited to, a sensing channel 165 that performs the sensing operation, the initialization switch SW_INIT that applies the initialization voltage VINIT to the sensing line SL in response to an initialization switching signal INIT_SWS, and a sampling switch SW_SPL that connects the sensing line SL to the sensing channel 165 in response to a sampling switching signal SPL_SWS. For example, as illustrated in FIGS. 10 through 12, the sensing channel 165 may include, but is not limited to, a sampling capacitor CSAM in which the sensing current ISEN of the driving transistor T1 received through the sensing line SL is accumulated, and an analog-to-digital converter ADC that generates a digital sensing signal DSS by performing an analog-to-digital converting operation on a voltage of the sensing line SL. Although one sensing channel 165 is illustrated in FIG. 1, in some embodiments, the number of sensing channels 165 of the sensing circuit 160 may be substantially the same as the number of sensing lines SL of the display panel 110. In other embodiments, the sensing circuit 160 may include one sensing channel 165 per two or more sensing lines SL. In some embodiments, the sensing circuit 160 may be implemented as an integrated circuit separate from an integrated circuit of the data driver 140. In other embodiments, the sensing circuit 160 may be included in the data driver 140 or the controller 170.

The controller 170 (e.g., a timing controller (TCON)) may receive input image data IDAT and a control signal CTRL from an external host processor (e.g., an application processor (AP), a graphics processing unit (GPU), or a graphics card. In some embodiments, the control signal CTRL may include, but is not limited to, a vertical synchronization signal, a horizontal synchronization signal, an input data enable signal, and a master clock signal. In some embodiments, the controller 170 may generate the output image data ODAT by correcting the input image data IDAT based on the digital sensing signal DSS received from the sensing circuit 160. Further, the controller 170 may generate the data control signal DCTRL, the scan control signal SCTRL, and a power control signal PCTRL based on the control signal CTRL. The controller 170 may control the scan driver 130 by providing the scan control signal SCTRL to the scan driver 130, may control the data driver 140 by providing the output image data ODAT and the data control signal DCTRL to the data driver 140, and may control the power management circuit 150 by providing the power control signal PCTRL to the power management circuit 150.

In the display device 100 according to embodiments, the panel driver 120 may drive the display panel 110 at a variable frame frequency VFF. For example, as illustrated in FIG. 3, each frame period FP1, FP2, and FP3 may have the active period AP1, AP2, and AP3 having a constant (or fixed) time length, but a frequency of each frame period FP1, FP2, and FP3 may be changed by a time length of the blank period BP1, BP2, and BP3 of the frame period FP1, FP2, and FP3. In the example of FIG. 3, the panel driver 120 may drive the display panel 110 at the variable frame frequency VFF of about 120 Hz in a first frame period FP1, may drive the display panel 110 at the variable frame frequency VFF of about 48 Hz in a second frame period FP2, and may drive the display panel 110 at the variable frame frequency VFF of about 120 Hz in a third frame period FP3. In some embodiments, the controller 170 may receive the input image data IDAT from the external host processor at the variable frame frequency VFF, and may provide the output image data ODAT to the data driver 140 at the variable frame frequency VFF. Further, to drive the display panel 110 at the variable frame frequency VFF, the data driver 140 may provide the data voltages VDAT to the plurality of pixels PX of the display panel 110 at the variable frame frequency VFF. In one example, the variable frame frequency VFF may vary within a range between a maximum frame frequency of about 120 Hz and a minimum frame frequency of about 48 Hz, but is not limited thereto. In some embodiments, a mode of the display device 100 that drives the display panel 110 at the variable frame frequency VFF may be referred to as a variable frame mode. For example, the variable frame mode may be, but is not limited to, a free-sync mode, a G-sync mode, etc.

Further, in the display device 100 according to embodiments, the panel driver 120 may perform a sensing operation (or a real-time sensing operation) on at least one pixel PX of the display panel 110 in a blank period (or a vertical blank period) of a frame period. In some embodiments, the controller 170 of the panel driver 120 may randomly select one pixel row on which the sensing operation is to be performed among the plurality of pixel rows of the display panel 110 in each frame period, and the panel driver 120 may perform the sensing operation on the randomly selected pixel row in the blank period of the frame period. For example, as illustrated in FIG. 3, in a case where a K1-th pixel row is randomly selected in the first frame period FP1, the sensing operation may be performed on the K1-th pixel row by providing the scan and sensing signals SCK1 and SSK1 to the K1-th pixel row in the blank period BP1 of the first frame period FP1. Further, in a case where a K2-th pixel row is randomly selected in the second frame period FP2, the sensing operation may be performed on the K2-th pixel row by providing the scan and sensing signals SCK2 and SSK2 to the K2-th pixel row in the blank period BP2 of the second frame period FP2. In addition, in a case where a K3-th pixel row is randomly selected in the third frame period FP3, the sensing operation may be performed on the K3-th pixel row by providing the scan and sensing signals SCK3 and SSK3 to the K3-th pixel row in the blank period BP3 of the third frame period FP3. Here, in a case where the display panel 110 includes the first through N-th pixel rows, K1, K2 and K3 may be randomly selected integers in the range from 1 to N.

Further, after the sensing operation is performed on at least one pixel PX in each blank period, a data rewrite operation that writes the previous data voltage to the at least one pixel PX may be performed. However, in a case where the initialization voltage VINIT is not (actively or intentionally) changed in the blank period, as illustrated in FIG. 4, a voltage level of the initialization voltage VINIT at the pixel PX when the data rewrite operation is performed in the blank period BP may be lower than a voltage level of the initialization voltage VINIT at the pixel PX when a data write operation that writes the data voltage VDAT to the pixel PX is performed in the active period AP. A first timing diagram 210 of FIG. 4 illustrates examples of the scan and sensing signals SCK/SSK for a K-th pixel row and the initialization voltage VINIT in the active period AP, and a second timing diagram 230 of FIG. 4 illustrates examples of the scan and sensing signals SCK/SSK for the K-th pixel row and the initialization voltage VINIT in the blank period BP, where K is an integer between 1 and N. In the example of FIG. 4, when the data write operation is performed on the pixel PX in the K-th pixel row in the active period AP, the initialization voltage VINIT may rise (or increase) at a falling edge of the scan and sensing signals SCK/SSK for the K-th pixel row by the scan and sensing signals SCK+1/SSK+1 for a (K+1)-th pixel row. However, when the data rewrite operation is performed on the pixel PX in the K-th pixel row in the blank period BP, because other scan and sensing signals are not applied to the display panel 110 in the blank period BP, the initialization voltage VINIT may not rise at the falling edge of the scan and sensing signals SCK/SSK for the K-th pixel row. Thus, the voltage level of the initialization voltage VINIT when the data rewrite operation is performed in the blank period BP may be lower than the voltage level of the initialization voltage VINIT when the data write operation is performed in the active period AP. In this case, in the pixel PX on which the data rewrite operation is performed, even if the previous data voltage is substantially the same as the data voltage VDAT in the active period AP, the voltage difference between the previous data voltage and the initialization voltage VINIT stored in the storage capacitor CST after the data rewrite operation may be greater than the voltage difference between the data voltage VDAT and the initialization voltage VINIT stored in the storage capacitor CST in the active period AP. Accordingly, luminance of the pixel PX on which the sensing operation is performed may be increased in the blank period BP.

In addition, the luminance increase of the pixel PX on which the sensing operation is performed in the blank period BP may become greater as the variable frame frequency VFF decreases, and may become further greater in a case where the pixel PX is located in a lower region of the display panel 110. A first graph 310 of FIG. 5 illustrates luminance L1 of a first pixel on which the sensing operation is not performed, and luminance L2 of a second pixel on which the sensing operation is performed, in a case where the first and second pixels are located in a upper region of the display panel 110 and the variable frame frequency VFF is about 120 Hz. A second graph 330 of FIG. 5 illustrates luminance L3 of a third pixel on which the sensing operation is not performed, and luminance L4 of a fourth pixel on which the sensing operation is performed, in a case where the third and fourth pixels are located in the upper region of the display panel 110 and the variable frame frequency VFF is about 60 Hz. A third graph 350 of FIG. 5 illustrates luminance L5 of a fifth pixel on which the sensing operation is not performed, and luminance L6 of a sixth pixel on which the sensing operation is performed, in a case where the fifth and sixth pixels are located in the lower region of the display panel 110 and the variable frame frequency VFF is about 60 Hz. As illustrated in the first graph 310 of FIG. 5, in a case where the variable frame frequency VFF is a high frequency of about 120 Hz, and the second pixel on which the sensing operation is performed is located in the upper region of the display panel 110, although the luminance L2 of the second pixel is increased when the data rewrite operation is performed, the luminance L2 of the second pixel may be decreased when the sensing operation is performed, and thus an average of the luminance L2 of the second pixel during the entire frame period FP may not be substantially increased compared with an average of the luminance L1 of the first pixel. However, as illustrated in the second graph 330 of FIG. 5, in a case where the variable frame frequency VFF is decreased from the high frequency of about 120 Hz to a low frequency of about 60 Hz, because a time length of the blank period BP is increased, the luminance L4 of the fourth pixel on which the sensing operation is performed may have a luminance increase portion 340 for a long period of time after the data rewrite operation. Thus, in the case where the variable frame frequency VFF is the low frequency, the luminance L4 of the fourth pixel on which the sensing operation is performed may be increased compared with the luminance L3 of the third pixel on which the sensing operation is not performed. Further, as illustrated in the third graph 350 of FIG. 5, in a case where the sixth pixel on which the sensing operation is performed is located in the lower region of the display panel 110, because the data write operation for the sixth pixel is performed in a latter portion of the active period AP after the blank period BP in which the sensing operation is performed, the luminance L6 of the sixth pixel on which the sensing operation is performed may have a luminance increase portion 360 for a longer period of time. Thus, in the case where the variable frame frequency VFF is the low frequency and the fifth and sixth pixels are located in the lower region of the display panel 110, the luminance L6 of the sixth pixel on which the sensing operation is performed may be further increased as compared with the luminance L5 of the fifth pixel on which the sensing operation is not performed. Accordingly, when the variable frame frequency VFF is the low frequency and the pixel PX (or the pixel row) on which the sensing operation is performed in the blank period BP is located in the lower region of the display panel 110, a horizontal bright line may be perceived in the display panel 110.

However, in the display device 100 according to embodiments, the panel driver 120 may (actively or intentionally) change the initialization voltage VINIT according to the variable frame frequency VFF and according to a position of the pixel PX (or the pixel row) on which the sensing operation is performed within the blank period BP. In some embodiments, the panel driver 120 may increase the initialization voltage VINIT within the blank period BP as the variable frame frequency VFF decreases. Further, in some embodiments, the panel driver 120 may increase the initialization voltage VINIT within the blank period BP as a distance of the pixel PX (or the pixel row) on which the sensing operation is performed from an edge (or a top edge) of the display panel 110 increases. In some embodiments, the blank period BP may include an initialization period INIP, a sensing period SENP and a rewrite period REWP as illustrated in FIG. 9, and the panel driver 120 may change the initialization voltage VINIT after the initialization period INIP and before the rewrite period REWP. In one example, the panel driver 120 may increase the initialization voltage VINIT in the sensing period SENP. In another example, as illustrated in FIG. 9, the panel driver 120 may start increasing the initialization voltage VINIT when the initialization switching signal INIT_SWS is changed from an on-level to an off-level, or at a falling edge of the initialization switching signal INIT_SWS.

In some embodiments, to perform this operation, the controller 170 of the

panel driver 120 may include an initialization voltage lookup table (VINIT LUT) 180 that stores the initialization voltage VINIT in the blank period BP (or the rewrite period REWP) according to the variable frame frequency VFF with respect to each of a plurality of panel regions into which the display panel 110 is divided along a vertical direction (e.g., a pixel column direction or a direction in which each data line DL or each sensing line SL extends). Further, the controller 170 may control the power management circuit 150 to change the initialization voltage VINIT within the blank period BP by using the initialization voltage lookup table 180.

For example, as illustrated in FIG. 6A, the display panel 110 may be divided into first through tenth panel regions PR1, PR2, PR3, PR4, PR5, PR6, PR7, PR8, PR9 and PR10 each including a plurality of pixel rows. For example, the first panel region PR1 may have a plurality of pixel rows including the first pixel row that receives the first scan and sensing signals SC1/SS1, and the tenth panel region PR10 may have a plurality of pixel rows including the last pixel row that receives the N-th scan and sensing signals SCN/SSN. Further, as illustrated in FIG. 6B, the initialization voltage lookup table 180 may store a first initialization voltage at a maximum frame frequency MAX_FREQ of about 120 Hz, and a second initialization voltage at a minimum frame frequency MIN_FREQ of about 48 Hz with respect to each of the first through tenth panel regions PR1 through PR10. FIG. 6B may illustrate an example of the initialization voltage lookup table 180 in a case where the initialization voltage VINIT in the active period AP is about 2V.

In a case where the variable frame frequency VFF is the maximum frame frequency MAX_FREQ of about 120 Hz, and a sensing operation is performed on a pixel PX (or a pixel row) in the first panel region PR1, the panel driver 120 may not change the initialization voltage VINIT within the blank period BP by referring to the initialization voltage lookup table 180. However, in a case where the variable frame frequency VFF is the minimum frame frequency MIN_FREQ of about 48 Hz, and a sensing operation is performed on the pixel PX in the first panel region PR1, the panel driver 120 may increase the initialization voltage VINIT from about 2V to about 2.1V within the blank period BP by referring to the initialization voltage lookup table 180. Further, in a case where the variable frame frequency VFF is the maximum frame frequency MAX_FREQ of about 120 Hz and a sensing operation is performed on a pixel PX in the fifth panel region PR5, the panel driver 120 may increase the initialization voltage VINIT from about 2V to about 2.05V within the blank period BP by referring to the initialization voltage lookup table 180. In addition, in a case where the variable frame frequency VFF is the minimum frame frequency MIN_FREQ of about 48 Hz and a sensing operation is performed on the pixel PX in the fifth panel region PR5, the panel driver 120 may increase the initialization voltage VINIT from about 2V to about 2.2V within the blank period BP by referring to the initialization voltage lookup table 180. Further, in a case where the variable frame frequency VFF is the maximum frame frequency MAX_FREQ of about 120 Hz and a sensing operation is performed on a pixel PX in the tenth panel region PR10, the panel driver 120 may increase the initialization voltage VINIT from about 2V to about 2.1V within the blank period BP by referring to the initialization voltage lookup table 180. In addition, in a case where the variable frame frequency VFF is the minimum frame frequency MIN_FREQ of about 48 Hz and a sensing operation is performed on the pixel PX in the tenth panel region PR10, the panel driver 120 may increase the initialization voltage VINIT from about 2V to about 2.3V within the blank period BP by referring to the initialization voltage lookup table 180.

Further, in some embodiments, when the variable frame frequency VFF is between the maximum frame frequency MAX_FREQ of about 120 Hz and the minimum frame frequency MIN_FREQ of about 48 Hz, the controller 170 of the panel driver 120 may read (e.g., from the initialization voltage lookup table 180) the first initialization voltage at the maximum frame frequency MAX_FREQ and the second initialization voltage at the minimum frame frequency MIN_FREQ for a panel region to which the pixel PX (or the pixel row) on which the sensing operation is performed belongs, may determine a voltage level of the initialization voltage VINIT corresponding to the variable frame frequency VFF in the rewrite period REWP within the blank period BP by interpolating the first initialization voltage and the second initialization voltage, and may control the power management circuit 150 to change the voltage level of the initialization voltage VINIT to the determined voltage level before the rewrite period REWP within the blank period BP. For example, in a case where the variable frame frequency VFF is about 84 Hz and a sensing operation is performed on a pixel PX in the tenth panel region PR10, the panel driver 120 may increase the initialization voltage VINIT from about 2V to about 2.2V before the rewrite period REWP within the blank period BP by interpolating the first initialization voltage of about 2.1 V and the second initialization voltage of about 2.3V.

As described above, in the display device 100 according to embodiments, if the initialization voltage VINIT is increased within the blank period BP, increase of the luminance of the pixel (or the pixel row) on which the sensing operation is performed in the blank period BP may be reduced or prevented. That is, if the initialization voltage VINIT is increased before the rewrite period REWP, the voltage difference between the previous data voltage and the initialization voltage VINIT stored in the storage capacitor CST by the data rewrite operation in the rewrite period REWP may be decreased, and the luminance of the pixel PX after the rewrite period REWP may not be increased. A first graph 330 and a second graph 350 of FIG. 7 may correspond to the second graph 330 and the third graph 350 of FIG. 5, respectively, a third graph 330′ of FIG. 7 illustrates luminance L3 and L4′ of the third and fourth pixels when the initialization voltage VINIT is increased within the blank period BP according to embodiments, and a fourth graph 350′ of FIG. 7 represents luminance L5 and L6′ of the fifth and sixth pixels when the initialization voltage VINIT is increased within the blank period BP according to embodiments. As illustrated in the third graph 330′ of FIG. 7, even if the variable frame frequency VFF is decreased from the high frequency of about 120 Hz to the low frequency of about 60 Hz, the initialization voltage VINIT may be increased within the blank period BP, and thus the luminance L4′ of the fourth pixel on which the sensing operation is performed may be decreased in the luminance increase portion 340′. Further, as illustrated in the fourth graph 350′ of FIG. 7, even if the sixth pixel on which the sensing operation is performed is located in the lower region of the display panel 110, the initialization voltage VINIT within the blank period BP may be further increased, and thus the luminance L6′ of the sixth pixel on which the sensing operation is performed may be decreased in the luminance increase portion 360′. Accordingly, even if the variable frame frequency VFF is the low frequency, and the pixel PX (or the pixel row) on which the sensing operation is performed in the blank period BP is located in the lower region of the display panel 110, the horizontal bright line may not be perceived in the display panel 110.

As described above, in the display device 100 according to embodiments, the sensing operation may be performed on the pixel PX (or the pixel row) within the blank period BP, and the initialization voltage VINIT applied to the pixel PX when the data rewrite operation is performed may be changed (e.g., increased) according to the variable frame frequency VFF and according to the position of the pixel PX (or the pixel row). Accordingly, change (e.g., increase) of the luminance of the pixel PX (or the pixel row) on which the sensing operation is performed in the blank period BP may be reduced or prevented, and the horizontal bright line may not be perceived in the display panel 110.

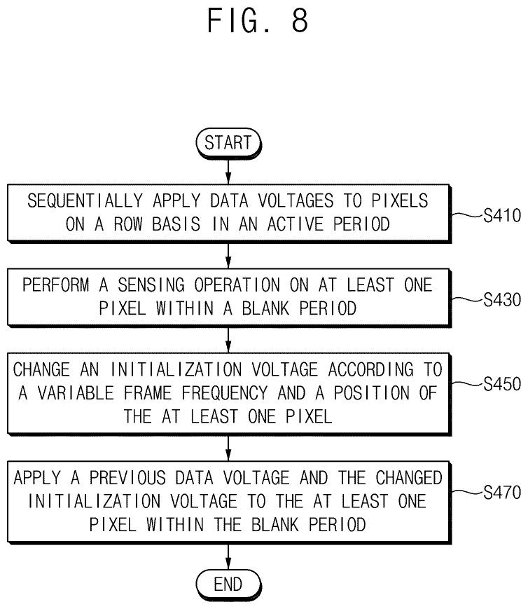

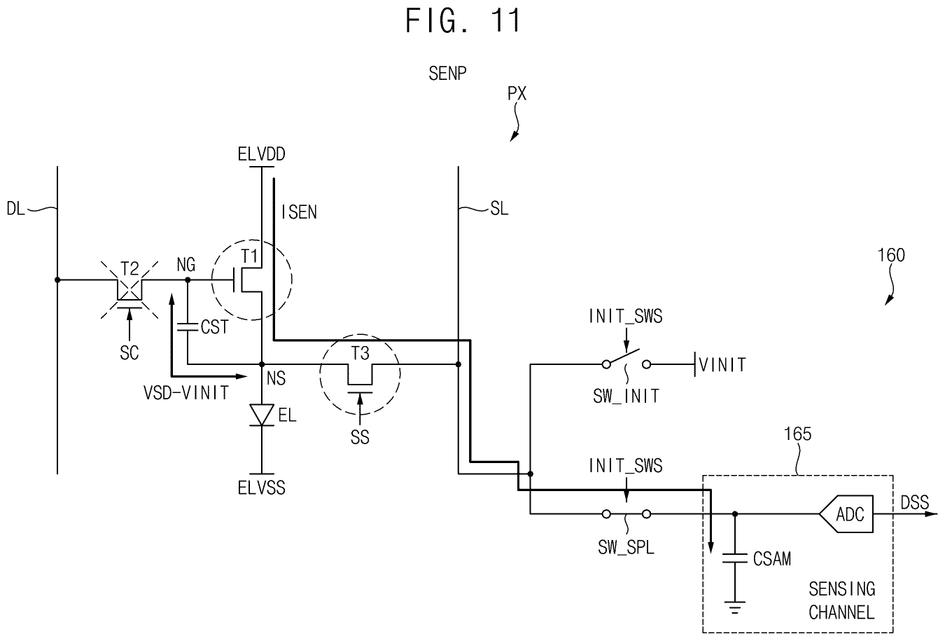

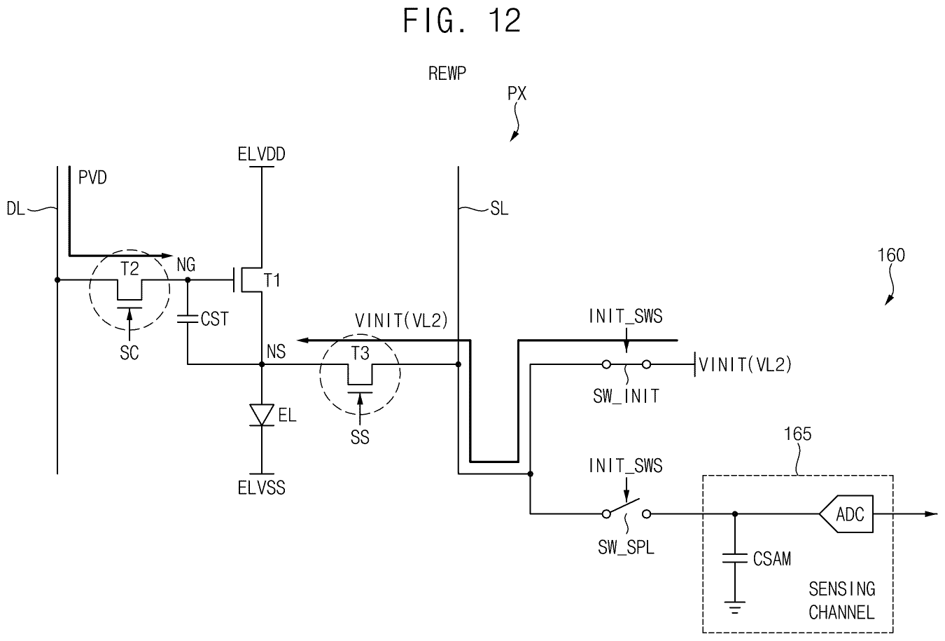

FIG. 8 is a flowchart illustrating a method of operating a display device according to embodiments, FIG. 9 is a timing diagram for describing an operation of a pixel in which a sensing operation is performed in a blank period and an operation of a sensing circuit in a display device according to embodiments, FIG. 10 is a circuit diagram for describing an example of operations of a pixel and a sensing circuit in an initialization period within a blank period, FIG. 11 is a circuit diagram for describing an example of operations of a pixel and a sensing circuit in a sensing period within a blank period, and FIG. 12 is a circuit diagram for describing an example of operations of a pixel and a sensing circuit in a rewrite period within a blank period.

Referring to FIGS. 1 and 8, a panel driver 120 may sequentially apply data voltages VDAT to a plurality of pixels PX on a row basis in an active period of a frame period (S410). For example, in the active period, a scan driver 130 may sequentially provide scan signals SC and sensing signals SS on the row basis to the plurality of pixels PX, and the data driver 140 may provide the data voltages VDAT to the plurality of pixels PX through data lines DL.

In a blank period of the frame period, the panel driver 120 may perform a sensing operation on at least one pixel PX (or at least one pixel row) (S430). In some embodiments, the panel driver 120 may perform the sensing operation on a randomly selected pixel row in the blank period of each frame period. Further, in some embodiments, as illustrated in FIG. 9, the blank period BP may include an initialization period INIP, a sensing period SENP and a rewrite period REWP.

For example, as illustrated in FIGS. 9 and 10, in the initialization period INIP, a sensing data voltage VSD may be applied to a gate node NG of the pixel PX on which the sensing operation is to be performed, and an initialization voltage VINIT may be applied to a source node NS of the pixel PX on which the sensing operation is to be performed. That is, in the initialization period INIP, an initialization switching signal INIT_SWS, a scan signal SC and a sensing signal SS have an on-level (e.g., a high level), and a sampling switching signal SPL_SWS may have an off-level (e.g., a low level). An initialization switch SW_INIT may apply the initialization voltage VINIT to a sensing line SL in response to the initialization switching signal INIT_SWS having the on-level. A scan transistor T2 may be turned on in response to the scan signal SC having the on-level, and may transfer the sensing data voltage VSD of the data line DL to the gate node NG. A sensing transistor T3 may be turned on in response to the sensing signal SS having the on-level, and may transfer the initialization voltage VINIT of the sensing line SL to the source node NS. Thus, a storage capacitor CST may store a voltage difference between the sensing data voltage VSD and the initialization voltage VINIT.

Further, as illustrated in FIGS. 9 and 11, in the sensing period SENP, the sensing operation may be performed on the pixel PX (or the pixel row). In the sensing period SENP, the sensing signal SS and the sampling switching signal SPL_SWS may have the on-level (e.g., the high level), and the initialization switching signal INIT_SWS and the scan signal SC may have the off-level (e.g., the low level). The sensing transistor T3 may be turned on in response to the sensing signal SS having the on- level, and may connect the source node NS to the sensing line SL. A driving transistor T1 may generate a sensing current ISEN based on the voltage difference between the sensing data voltage VSD and the initialization voltage VINIT stored in the storage capacitor CST. A sampling switch SW_SPL may connect the sensing line SL to a sensing channel 165 in response to the sampling switching signal SPL_SWS having the on-level. The sensing channel 165 may sense the sensing current ISEN through the sensing line SL. For example, when the sensing current ISEN is accumulated in the sampling capacitor CSAM of the sensing channel 165, a voltage V_SL of the sensing line SL may be gradually increased. An analog-digital converter ADC of the sensing channel 165 may convert the voltage V_SL of the sensing line SL into a digital sensing signal DSS. In some embodiments, the sensing channel 165 may sense a mobility of the driving transistor T1 by measuring, as the voltage V_SL of the sensing line SL, a first voltage V1 at a first time point TP1 and a second voltage V2 at a second time point TP2. However, an operation of the sensing channel 165 is not limited thereto.

The panel driver 120 may change the initialization voltage VINIT from a first voltage level VL1 to a second voltage level VL2 within the blank period BP according to a variable frame frequency VFF and according to a position of the at least one pixel PX (or the at least one pixel row) (S450). In some embodiments, the initialization voltage VINIT within the blank period BP may increase as the variable frame frequency VFF decreases, and may increase as a distance of the at least one pixel PX from an edge (e.g., a top edge) of the display panel 110 increases. Further, in some embodiments, the panel driver 120 may increase the initialization voltage VINIT from the first voltage level VL1 to the second voltage level VL2 after the initialization period INIP and before the rewrite period REWP. In one example, the panel driver 120 may increase the initialization voltage VINIT within the sensing period SENP. In another example, as illustrated in FIG. 9, the panel driver 120 may change the initialization switching signal INIT_SWS from the on-level (e.g., the high level) to the off-level (e.g., the low level) between the initialization period INIP and the sensing period SENP, and may change the initialization voltage VINIT from the first voltage level VL1 to the second voltage level VL2 at substantially the same time, or at a falling edge of the initialization switching signal INIT_SWS. In this case, the initialization voltage VINIT may be stably increased to the second voltage level VL2 before the rewrite period REWP.

The panel driver 120 may apply a previous data voltage PVD and the initialization voltage VINIT changed (e.g., increased) to the second voltage level VL2 to the at least one pixel PX (or the at least one pixel row) within the blank period BP (S470). Here, the previous data voltage PVD may be a data voltage VDAT applied to the at least one pixel PX in an active period immediately before the blank period BP.

For example, as illustrated in FIGS. 9 and 12, in the rewrite period REWP within the blank period BP, the previous data voltage PVD may be applied to the gate node NG, and the initialization voltage VINIT having the second voltage level VL2 may be applied to the source node NS. In the rewrite period REWP, the scan signal SC, the sensing signal SS, and the initialization switching signal INIT_SWS may have the on-level (e.g., the high level), and the sampling switching signal SPL_SWS may have the off-level (e.g., the low level). The initialization switch SW_INIT may apply the initialization voltage VINIT having the second voltage level VL2 to the sensing line SL in response to the initialization switching signal INIT_SWS having the on-level. The scan transistor T2 may be turned on in response to the scan signal SC having the on-level, and may transfer the previous data voltage PVD of the data line DL to the gate node NG. The sensing transistor T3 may be turned on in response to the sensing signal SS having the on-level, and may transfer the initialization voltage VINIT having the second voltage level VL2 of the sensing line SL to the source node NS. Thus, the storage capacitor CST may store the voltage difference between the previous data voltage PVD and the initialization voltage VINIT having the second voltage level VL2. Accordingly, the luminance of the pixel PX (or the pixel row) on which the sensing operation is performed may not substantially increase. Further, the second voltage level VL2 may increase as the variable frame frequency VFF decreases, and may increase the distance from the edge of the display panel 110 to the pixel PX (or the pixel row) on which the sensing operation is performed increases. Accordingly, change (e.g., increase) of the luminance of the pixel PX (or the pixel row) on which the sensing operation is performed in the blank period BP may be reduced or prevented, and a horizontal bright line may not be perceived in the display panel 110.

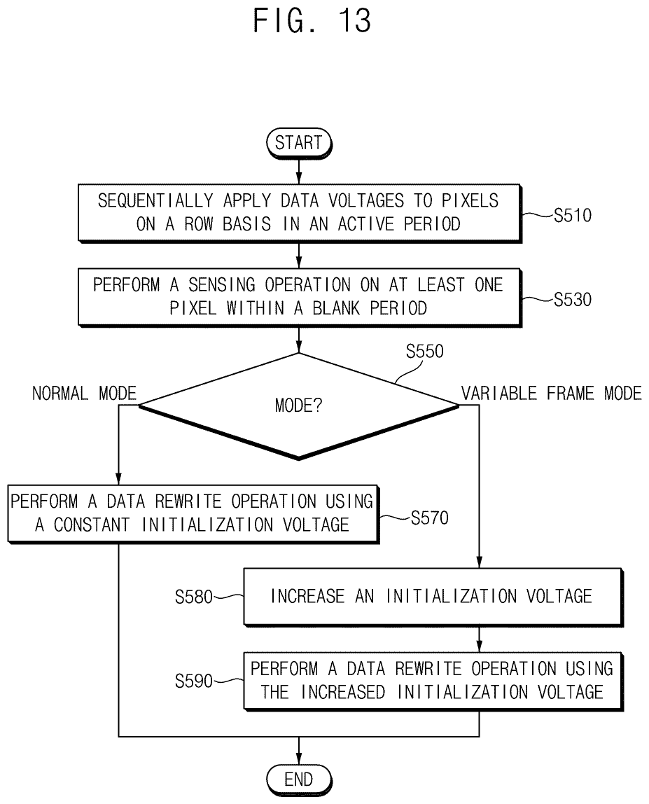

FIG. 13 is a flowchart illustrating a method of operating a display device according to embodiments.

Referring to FIGS. 1 and 13, a panel driver 120 may sequentially apply data voltages VDAT to a plurality of pixels PX on a row basis in an active period of a frame period (S510). Further, in a blank period of the frame period, the panel driver 120 may perform a sensing operation on at least one pixel PX (or at least one pixel row) (S530). In a normal mode in which the panel driver 120 drives a display panel 110 at

a fixed frame frequency (e.g., about 120 Hz) (S550: NORMAL MODE), the panel driver 120 may not change an initialization voltage VINIT in the blank period, and may perform a data rewrite operation that writes a previous data voltage to the pixel PX on which the sensing operation is performed by using the constant initialization voltage VINIT within the blank period (S570). In the normal mode, even if the initialization voltage VINIT is not increased within the blank period, because the display panel 110 is driven at a relatively high frame frequency (e.g., about 120 Hz), a horizontal bright line may not be perceived.

Alternatively, in a variable frame mode in which the panel driver 120 drives the display panel 110 at a variable frame frequency VFF (e.g., varying in the range from about 48 Hz to about 120 Hz) (S550: VARIABLE FRAME MODE), the panel driver 120 may change (e.g., increase) the initialization voltage VINIT in the blank period (S580), and may perform the data rewrite operation that writes the previous data voltage to the pixel PX on which the sensing operation is performed by using the changed (e.g., increased) initialization voltage VINIT within the blank period (S590). In some embodiments, the initialization voltage VINIT may be increased to a voltage level (e.g., predetermined voltage level) before the data rewrite operation is performed within the blank period, and the voltage level (e.g., predetermined voltage level) may be determined such that luminance of a pixel PX located in a lower region of the display panel 110 may not be increased at the minimum frame frequency (e.g., about 48 Hz) by the data rewrite operation. Accordingly, in the method of operating the display device 100 according to embodiments, increase of the luminance of the pixel PX (or the pixel row) on which the sensing operation is performed may be reduced or prevented, and a horizontal bright line may not be perceived in the display panel 110.

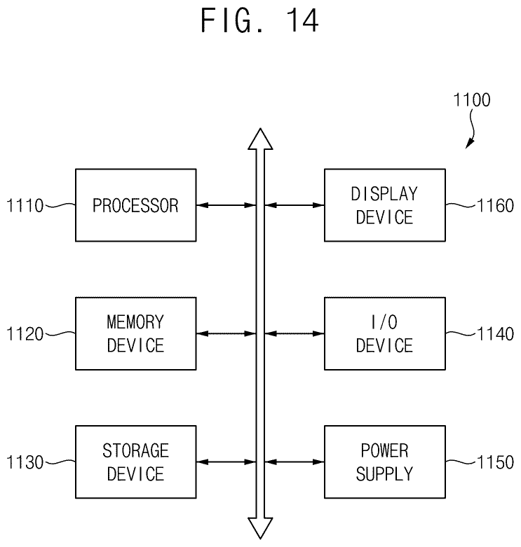

FIG. 14 is a block diagram illustrating an example of an electronic device according to embodiments.

Referring to FIG. 14, an electronic device 1100 may include a processor 1110, a memory device 1120, a storage device 1130, an input/output (I/O) device 1140, a power supply 1150, and a display device 1160. The electronic device 1100 may further include a plurality of ports for communicating with a video card, a sound card, a memory card, a universal serial bus (USB) device, other electronic devices, etc.

The processor 1110 may perform various computing functions or tasks. The processor 1110 may be an application processor (AP), a micro-processor, a central processing unit (CPU), etc. The processor 1110 may be connected to other components via an address bus, a control bus, a data bus, etc. Further, in some embodiments, the processor 1110 may be further connected to an extended bus such as a peripheral component interconnection (PCI) bus.

The memory device 1120 may store data for operations of the electronic device 1100. For example, the memory device 1120 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile dynamic random access memory (mobile DRAM) device, etc.

The storage device 1130 may be a solid state drive (SSD) device, a hard disk drive (HDD) device, a CD-ROM device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be connected to other components through the buses or other communication links.

In the display device 1160, within a blank period of a frame period, a sensing operation for a pixel may be performed, and an initialization voltage applied to the pixel may be changed according to a variable frame frequency and a position of the pixel. Accordingly, change of the luminance of the pixel on which the sensing operation is performed in the blank period may be reduced or prevented, and a horizontal bright line may not be perceived in a display panel of the display device 1160.

The present disclosure may be applied to any electronic device 1100 including the display device 1160. For example, the present disclosure may be applied to a television (TV) (e.g., a digital TV, a three-dimensional (3D) TV, etc.), a smart phone, a wearable electronic device, a tablet computer, a mobile phone, a personal computer (PC), a home appliance, a laptop computer, a personal digital assistant (PDA), a portable multimedia player (PMP), a digital camera, a music player, a portable game console, a navigation device, etc.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims, with functional equivalents thereof to be included therein.

What is claimed is:

1. A display device comprising:
a display panel comprising pixels; and
a panel driver configured to drive the display panel at a variable frame frequency, to sequentially apply data voltages to the pixels on a row basis in an active period of a frame period, and to perform a sensing operation on at least one pixel among the pixels in a blank period of the frame period,
wherein, within the blank period, the panel driver is configured to change an initialization voltage applied to the at least one pixel according to the variable frame frequency and according to a position of the at least one pixel.

2. The display device of claim 1, wherein the panel driver is configured to increase the initialization voltage within the blank period as the variable frame frequency decreases.

3. The display device of claim 1, wherein the panel driver is configured to increase the initialization voltage within the blank period as a distance of the at least one pixel from an edge of the display panel increases.

4. The display device of claim 1, wherein the at least one pixel comprises:
a driving transistor comprising a gate connected to a gate node, a first terminal connected to a first power supply voltage line, and a second terminal connected to a source node;
a scan transistor comprising a gate that receives a scan signal, a first terminal connected to a data line, and a second terminal connected to the gate node;
a sensing transistor comprising a gate that receives a sensing signal, a first terminal connected to a sensing line, and a second terminal connected to the source node;
a storage capacitor comprising a first electrode connected to the gate node, and a second electrode connected to the source node; and
a light-emitting element comprising an anode connected to the source node, and a cathode connected to a second power supply voltage line.

5. The display device of claim 4, wherein the blank period comprises:
an initialization period in which a sensing data voltage is to be applied to the gate node and the initialization voltage is to be applied to the source node;
a sensing period in which the sensing operation is to be performed; and
a rewrite period in which a previous data voltage is to be applied to the gate node and the initialization voltage is to be applied to the source node.

6. The display device of claim 5, wherein the initialization voltage is to be changed after the initialization period and before the rewrite period.

7. The display device of claim 5, wherein the initialization voltage is to be changed within the sensing period.

8. The display device of claim 5, wherein the previous data voltage comprises a data voltage applied to the at least one pixel in the active period.

9. The display device of claim 5, wherein the panel driver comprises:
a sensing channel configured to perform the sensing operation;
an initialization switch configured to apply the initialization voltage to the sensing line in response to an initialization switching signal; and
a sampling switch configured to connect the sensing line to the sensing channel in response to a sampling switching signal.

10. The display device of claim 9, wherein, in the initialization period:
the initialization switching signal, the scan signal, and the sensing signal have an on-level, and the sampling switching signal has an off-level;
the initialization switch is configured to apply the initialization voltage to the sensing line in response to the initialization switching signal having the on-level;
the scan transistor is configured to turned on in response to the scan signal having the on-level, and to transfer the sensing data voltage of the data line to the gate node;
the sensing transistor is configured to be turned on in response to the sensing signal having the on-level, and to transfer the initialization voltage of the sensing line to the source node; and
the storage capacitor is configured to store a voltage difference between the sensing data voltage and the initialization voltage.

11. The display device of claim 9, wherein the initialization switching signal is configured to be changed from an on-level to an off-level between the initialization period and the sensing period, and
wherein the initialization voltage begins to be increased when the initialization switching signal is changed from the on-level to the off-level.

12. The display device of claim 9, wherein, in the sensing period:
the sensing signal and the sampling switching signal have an on-level, and the initialization switching signal and the scan signal have an off-level;
the sensing transistor is configured to be turned on in response to the sensing signal having the on-level, and to connect the source node to the sensing line;
the driving transistor is configured to generate a sensing current based on a voltage difference between the sensing data voltage and the initialization voltage;
the sampling switch is configured to connect the sensing line to the sensing channel in response to the sampling switching signal having the on-level; and
the sensing channel is configured to sense the sensing current through the sensing line.

13. The display device of claim 9, wherein, in the rewrite period:
the scan signal, the sensing signal, and the initialization switching signal have an on-level, and the sampling switching signal has an off-level;
the initialization switch is configured to apply the initialization voltage to the sensing line in response to the initialization switching signal having the on-level;
the scan transistor is configured to be turned on in response to the scan signal having the on-level, and to transfer the previous data voltage of the data line to the gate node;
the sensing transistor is configured to be turned on in response to the sensing signal having the on-level, and to transfer the initialization voltage of the sensing line to the source node; and
the storage capacitor is configured to store a voltage difference between the previous data voltage and the initialization voltage.

14. The display device of claim 1, wherein the panel driver comprises:
a data driver connected to the pixels through data lines;
a power management circuit configured to provide a first power supply voltage, a second power supply voltage, and the initialization voltage to the display panel;
a sensing circuit connected to the pixels through sensing lines; and
a controller connected to control the data driver, the sensing circuit, and the power management circuit.

15. The display device of claim 14, wherein, in the frame period, the controller is configured to select one pixel row on which the sensing operation is performed within the blank period among pixel rows of the display panel.

16. The display device of claim 14, wherein the controller comprises an initialization voltage lookup table configured to store the initialization voltage in a rewrite period according to the variable frame frequency with respect to panel regions into which the display panel is divided along a vertical direction, and
wherein the controller is configured to control the power management circuit to change the initialization voltage within the blank period.

17. The display device of claim 16, wherein the initialization voltage lookup table is configured to store a first initialization voltage at a maximum frame frequency and a second initialization voltage at a minimum frame frequency with respect to the panel regions, and
wherein the controller is configured to read, from the initialization voltage lookup table, the first initialization voltage and the second initialization voltage for one of the panel regions to which the at least one pixel belongs, and to determine the initialization voltage corresponding to the variable frame frequency in the rewrite period by interpolating the first initialization voltage and the second initialization voltage.

18. A display device comprising:
a display panel comprising pixels; and
a panel driver configured to drive the display panel at a fixed frame frequency in a normal mode, to drive the display panel at a variable frame frequency in a variable frame mode, to sequentially apply data voltages to the pixels on a row basis in an active period of a frame period, and to perform a sensing operation on at least one pixel among the pixels in a blank period of the frame period,
wherein, in the normal mode, the panel driver is configured to apply an initialization voltage that is constant to the display panel, and
wherein, in the variable frame mode, the panel driver is configured to change the initialization voltage applied to the at least one pixel within the blank period.

19. A method of operating a display device configured to drive a display panel at a variable frame frequency, the method comprising:
sequentially applying data voltages on a row basis to pixels in an active period of a frame period;
performing a sensing operation on at least one pixel among the pixels within a blank period of the frame period;
changing an initialization voltage applied to the at least one pixel according to the variable frame frequency and according to a position of the at least one pixel; and
applying a previous data voltage and the changed initialization voltage to the at least one pixel within the blank period.

20. The method of claim 19, the initialization voltage within the blank period is configured to increase as the variable frame frequency decreases, and to increase as a distance of the at least one pixel from an edge of the display panel increases.
